(19) United States
(12) Patent Application Publication
(10) Pub. No.: US 2025/0142408 A1
(43) Pub. Date: May 1, 2025

(54) DEFERRING LOAD DURING A PEAK PERIOD ON A CORE NETWORK

(71) Applicant: Microsoft Technology Licensing, LLC, Redmond, WA (US)

(72) Inventor: Devesh VERMA, Delhi (IN)

(21) Appl. No.: 18/499,826

(22) Filed: Nov. 1, 2023

(51) Int. Cl. H04W 28/082; H04L 65/1016; H04W 28/02

(52) U.S. Cl. CPC H04W 28/082; H04W 28/0289; H04L 65/1016

(57) ABSTRACT

The present disclosure generally relates to deferring one or more load actions on a network function, such as a session management function (SMF), while providing access to communication-related services in a telecommunications network (e.g., a 5G mobile network). Systems described herein involve determining whether the SMF or core network of a telecommunications network is experiencing peak load conditions (e.g., a period of high network traffic) and, based on the determined peak load condition, causing one or more processes to be deferred or otherwise modified during the period of peak load. In this manner, the systems described herein preserve as much bandwidth and processing resources as possible in an effort to avoid degradation of communication applications and services, such as during voice and/or audio calls.

### FIELD OF TECHNOLOGY

This disclosure relates to deferring load of a network function during peak periods of traffic in a telecommunications network. More specifically, this disclosure pertains to deferring load by deferring certain session management actions during a period of peak load conditions on a core network.

### BACKGROUND

Cellular networks can provide computing devices (e.g., mobile devices) with access to services available from one or more data networks. A cellular network is typically distributed over geographical areas that include one or more base stations and core network devices that provide a cell with network coverage. The devices of the cellular network provide reliable access to a data network by mobile devices over a wide geographic area. In many instances these cellular networks provide mobile devices access to the cloud.

As noted above, cellular networks include a number of network components. For example, cellular networks often include a radio access network (RAN) and a core network. The RAN may include base stations that communicate wirelessly with user devices (e.g., mobile devices) and facilitate interaction with components of a core network. The core network may provide access to services and data available from one or more external networks. As noted above, cellular networks are often used to provide Internet connectivity to mobile devices.

As will be discussed in further detail herein, a core network may provide a variety of functions, including functions and services that provide Internet protocol (IP) connectivity for both data and voice services, ensuring this connectivity fulfills the promised QoS requirements, ensuring that user devices are properly authenticated, tracking user mobility to ensure uninterrupted service, and tracking subscriber usage for billing and charging.

Provisioning network resources can present a number of difficultly, particularly because the provisioned resources need to be able to accommodate network traffic and a volume of communications that are transmitted during both peak and non-peak hours. As a result, network resources are often optimized during peak periods, but underutilized during non-peak periods. Notwithstanding many optimizations on network resources, many networking environments struggle to provide reliable and high quality service during peak periods as a result of a high volume of calls and high-demand communication sessions simultaneously operating on the telecommunications network. Indeed, many current telecommunication systems are unable to accommodate high volumes of sessions, which causes the quality of experience of consumers to degrade in the form of slower connections and dropped calls.

The subject matter in the background section is intended to provide an overview of the overall context for the subject matter disclosed herein. The subject matter discussed in the background section should not be assumed to be prior art merely as a result of its mention in the background section. Similarly, a problem mentioned in the background section or associated with the subject matter of the background section should not be assumed to have been previously recognized in the prior art.

### BRIEF DESCRIPTION OF THE DRAWINGS

FIG. 1 illustrates an example telecommunications network environment including a load deferral system implemented on a network function of a core network.

FIG. 2 illustrates the load deferral system implemented on a session management function (SMF) in accordance with one or more embodiments.

FIGS. 3A-3B illustrate example implementations of a standard policy applied during a non-peak load period and a deferral action policy applied during a peak load period in accordance with one or more embodiments.

FIG. 4 illustrates an example series of acts for selectively applying a deferral action policy based on current load conditions of a core network in accordance with one or more embodiments.

FIG. 5 illustrates an example series of acts for initiating a communication session using an action deferral policy in accordance with one or more embodiments.

FIG. 6 illustrates an example series of acts for transitioning between a standard policy and an action deferral policy in accordance with one or more embodiments.

FIG. 7 illustrates certain components that may be included within a computer system.

### DETAILED DESCRIPTION

The present disclosure relates to systems, methods, and computer-readable media for deferring certain load-causing actions performed by a network function (a session management function (SMF)) while providing access to communication-related services in a telecommunications network (e.g., a fifth-generation (5G) mobile communication network). The systems described herein involve features provided by a network function that selectively defer certain actions in an effort to provide additional bandwidth and communication capabilities to accommodate periods of high traffic in the telecommunications network. As will be discussed in further detail below, the network function(s) may selectively implement a deferral action policy that involves causing the network function(s) to defer certain actions and interactions between the network function and other network functions on a core network when initiating a communication session or simply continuing to carry out a communication session over the telecommunications network.

As a first illustrative example, a network function (e.g., an SMF in a core network of a 5G mobile communication network) receives a session request associated with initiating a communication session. The network function determines that a load of the core network at a time the session request is received exceeds a threshold load indicating a period of peak capacity (e.g., peak load conditions) of the core network in handling communication communications. Based on the state of peak capacity, the network function determines a deferral action policy to apply to a communication session responsive to the session request. The network function then causes a communication session to be initiated in response to the session request in which the deferral action policy is applied to the communication session.

As a second illustrative example, a network function (e.g., an SMF in a core network of a 5G mobile communication network) receives a session request associated with initiating a communication session and, in response to the request, causes the communication session to be initiated using a standard policy associated with a period of non-peak capacity of the core network. At some point during the communication session, the network function determines that a load of the core network exceeds a load threshold and determines, based on the load exceeding the threshold, a deferral action policy associated with a period of peak capacity of the core network to apply to the communication session in lieu of the standard policy. The network function then causes the communication session to continue in which the deferral action policy is applied to the communication session for as long as a current load of the core network exceeds the threshold load.

As will be discussed herein, the present disclosure includes a number of practical applications having features described herein that provide benefits and/or solve problems associated with managing communication sessions that take place over a telecommunications network. It will be appreciated that benefits discussed herein are provided by way of example and are not intended to be an exhaustive list of all possible benefits of the management system(s) described herein.

By selectively deferring one or more session management actions, a communication load deferral system (or simply “load deferral system”) described herein can increase available bandwidth and resources when facilitating communication between devices via a telecommunications network. In particular, the load deferral system can defer certain tasks or actions performed by a session management function (SMF) to increase available resources and bandwidth during periods of peak capacity when a high volume of communications are being transmitted between devices via the core network. Indeed, by reducing load on the core network in this manner, the load deferral system can avoid degradation of call quality and/or effectively reduce the number of dropped communication sessions that will typically occur in greater frequency during peak hours.

This increase in network resources can be provided with minimal impact on the functionality of communication services hosted on a cloud computing system (e.g., including the core network). For example, in one or more implementations, the load deferral system stops or holds onto communications intended for a charging function during a peak period. While this deferral of communications with a charging function may delay actions associated with charging communications between users of the telecommunications network, this delay is not front-facing and does not interrupt the quality of service (QOS) or the front-facing user-experience in a significant way. Further, many charging actions can be deferred or put off to a later time when resources are not overtaxed during a peak period.

As another example, in one or more embodiments, the load deferral system stops or holds onto actions associated with retrieving policies based on a particular session initiation request. For example, the load deferral system may cause an SMF to stop fetching or obtaining a policy based on information contained within a session request, but rather identify a locally stored policy with a local or default policy to apply to a given communication session. Similar to above, this will often have a minimal impact on the quality of a given communication session, and will free up resources of the core network (e.g., on the SMF of the core network) to manage or otherwise facilitate more important or crucial services on the telecommunications network. As will be discussed below, other deferral actions may be performed in an effort to defer load from peak periods of activity on the core network.

It will be noted that the load deferral system may cause certain actions to be deferred to selective types of applications, and particularly to communication sessions, which are a uniquely difficult type of service to defer a large number of session management actions. Indeed, where conventional services can perform a variety of power mitigation actions, such as throttling processing speed or simply shutting off certain tasks temporarily, communication services are largely real-time services that are customer facing and have very little tolerance for reductions in capacity. Thus, the load deferral system described herein provides a valuable increase in effective resources in a manner that is unique to communication services and not necessarily applicable to other types of services, such as back-end services in which a significant number of tasks or the services themselves can be deferred to a later time when the core network is not experiencing peak load conditions.

Furthermore, in one or more embodiments, the load deferral system can defer certain actions or processes to periods of non-peak capacity on the core. Thus, the load deferral system can defer different processes that are deferred from the peak periods to be performed later during periods in which some quantity of network resources that would normally be used remain unused during the peak period of capacity. In some instances, the load deferral system may preserve resources for unexpected usage spikes by spacing out performance of the deferred actions over some period of time (e.g., after the peak capacity).

As illustrated in the foregoing discussion and as will be discussed in further detail herein, the present disclosure utilizes a variety of terms to describe features and advantages of methods and systems described herein. Some of these terms will be discussed in further detail below.

As used herein, a “server node” or “computing node” may refer interchangeably to any device (e.g., network device, server device) implemented on a cellular network (or core network portion of a cellular network) that has a defined functionality that the device can offer to the overall network architecture. Each computing node may have (or be configured to have) a respective set of defined functions in the network architecture. In one or more embodiments described herein, computing node may refer to a session management function (SMF) having responsibility for managing a variety of sessions (e.g., communication sessions) that involve communicating traffic (e.g., audio and/or video traffic) between devices on the cellular network.

As used herein, a “communication session” refers to a connection in which a user equipment (UE) or other endpoint device obtains a connection or access to or more services hosted by a network (e.g., a cloud computing system, a telecommunications network). In the context of one or more embodiments described herein, a communication session refers to a real-time connection in which voice and/or video communication are transmitted via components of a telecommunications network, such as between two user devices (e.g., two UEs). As used herein, a session request refers to any communication signal or message that is transmitted as part of a communication session hosted or otherwise accessible via the telecommunications network. As an example, a session initiation request refers to a request to initiate a communication session, which can be received at the SMF from a UE (e.g., via an access and mobility management function (AMF)). By way of example, example session requests may involve requests to initiate or create a session, a request to modify or update a session, or a request to delete a session. Indeed, session requests may refer to any communication or message that is received and processed (at least in part) at a management network function (e.g., an SMF). Additional detail in connection with different examples will be discussed below.

As used herein, a “load” refers to a metric of traffic quantity via one or more components of a telecommunications network. In one or more implementations described herein, a load refers to a load experienced by server nodes of a core network. In one or more implementations, the load refers to a quantity of traffic that is being transmitted over a period of time. During a period of peak capacity, the load may have a high metric of traffic quantity while during a period of non-peak capacity, the load may have a lower or normal metric of traffic quantity. Additional detail in connection with determining or predicting a load metric and determining whether the core network is experiencing peak or non-peak capacity will be discussed in further detail below.

As used herein, a “deferral action policy” refers to a set of rules or actions that are performed by a network function (e.g., an SMF) with respect to data, messages, or communications that are transmitted via resources of a telecommunications network. More specifically, a deferral action policy refers to rules or actions that are performed based on a load of the core network indicating a period of peak capacity. Examples of specific actions that the network function can perform pursuant to a deferral action policy will be discussed in further detail below.

In one or more embodiments, the telecommunications network is implemented as part of a cloud computing system. As used herein, a “cloud computing system” or “cloud computing network” refers to a network of connected computing devices that provide various services to computing devices (e.g., customer devices). For instance, as mentioned above, a distributed computing system can include a collection of physical server devices (e.g., server nodes) organized in a hierarchical structure including clusters, computing zones, virtual local area networks (VLANs), racks, fault domains, etc. In one or more embodiments described herein a portion of the cellular network (e.g., a core network) may be implemented in whole or in part on a cloud computing system. Moreover, in one or more embodiments a data network may be implemented on the same or on a different cloud computing network as the portion of the cellular network.

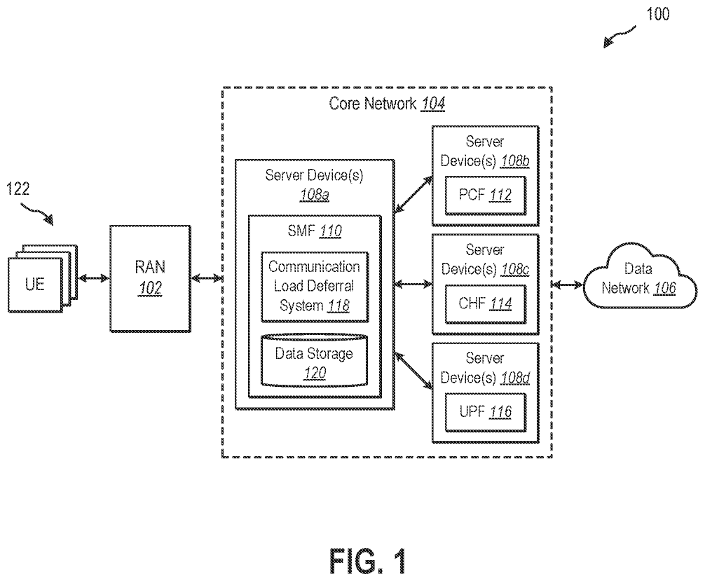

Additional details will now be provided regarding systems described herein in relation to illustrative figures portraying example implementations. For example, FIG. 1 illustrates an example environment 100 for implementing features and functionality of a communication load deferral system (or simply “load deferral system”) implemented on a network device within a core network of a telecommunications network. As shown in FIG. 1, the environment 100 includes a radio access network 102, a core network 104, and a data network 106. It will be appreciated that one or more features of the RAN 102, core network 104, and data network 106 may be implemented in whole or at least partially on a cloud computing system. For example, in one or more embodiments, portions of the RAN may be virtualized on server nodes of the cloud computing system while some or all of the core network components may be implemented on server nodes of the cloud computing system.

As shown in FIG. 1, a number of network functions may be implemented across a plurality of server nodes 108a-d. For example, a session management function (SMF) 110 and data storage 120 may be implemented on a first server node(s) 108a, a policy control function (PCF) 112 may be implemented on a second server node(s) 108b, a charging function (CHF) 114 may be implemented on a third server node(s) 108c, and a user plane function (UPF) 116 may be implemented on a fourth server node(s) 108d. Each of the respective functions may be implemented on or across multiple nodes. Features described herein are discussed in connection with single network functions being implemented on single server nodes, though it will be appreciated that the core network may include any number of the herein-discussed network functions implemented across any number of server nodes. Furthermore, the specific types of network functions discussed herein are provided by way of example and are not intended to be limiting to the only types of network functions included on the core network 104 or that may have tasks that are deferrable to time periods outside of a peak-periods on the core network 104. Indeed, it will be appreciated that the core network 104 may include any number network functions and a wide variety of different network function types for which actions or tasks may be deferred in accordance with one or more embodiments.

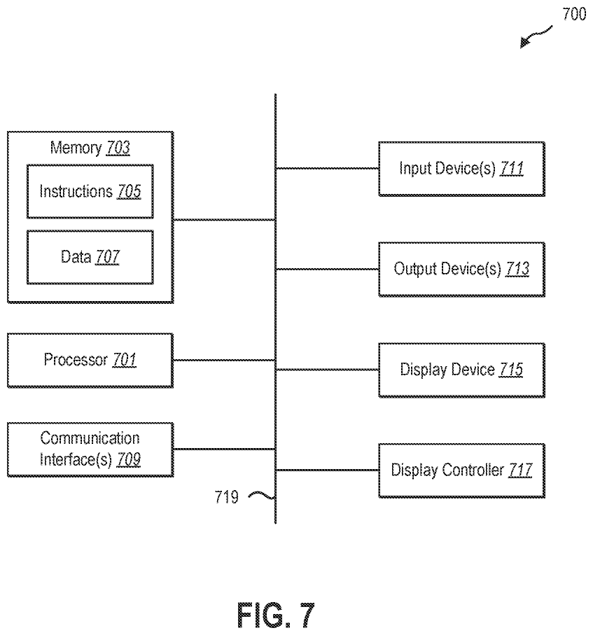

As shown in FIG. 1, the environment 100 may include a number of user equipments (UEs) 122. The UEs 122 may refer to a variety of computing devices or endpoints including, by way of example, a mobile device such as a mobile telephone, a smartphone, a personal digital assistant (PDA), a tablet, or a laptop. One or more of the UEs 122 may refer to non-mobile devices such as a desktop computer, a server device, or other non-portable devices that communicate with other endpoint devices via the telecommunications network. In one or more embodiments, the UEs 122 may refer to applications or software constructs on a computing device. Each of the devices of the environment 100 may include features and functionality described generally below in connection with FIG. 7.

As shown in FIG. 1, the UEs 122 may communicate with the core network 104 via a RAN 104. As mentioned above, one or more components of the environment 100 may be implemented within an architecture of a cellular network. For example, as noted above, a cellular network may include a radio access portion inclusive of a network of mobile towers (or base stations) in combination with components of a core network 104. Thus, as used herein, a cellular network may refer broadly to an architecture inclusive of the radio access network 102 including the mobile towers and computing nodes of the core network 104.

Each of the UEs 122, RAN 102, and components of the core network 104 may communicate via one or more networks. These networks may include one or more communication platforms or any technology for transmitting data. For example, a network may include the Internet or other data link that enables transport of electronic data between the UEs 122, the RAN 102, and components of the core network 104. In one or more embodiments, some or all of the components of the core network 104 are implemented on a cloud computing system. In addition, one or more embodiments of the RAN components may be virtualized and/or otherwise implemented as part of a cloud computing system. In one or more embodiments, components of the RAN 102 and/or core network 104 may be implemented on an edge network that has virtual connections to the internal data center(s) (e.g., the data network 106) of the cloud computing system.

As shown in FIG. 1, the SMF 110 includes a load deferral system 118 implemented thereon. As used herein, the load deferral system 118 provides features and functionality of an SMF 110 in causing one or more actions by network functions to be deferred from peak period to a non-peak period on the core network 104. In particular, as will be discussed below in connection with various examples, the load deferral system 118 causes the SMF 110 to defer one or more communications and/or actions taken with respect to the PCF 112, CHF 114, and/or UPF 116 in an effort to increase effective capacity of the SMF 110 and other network functions on the core network 104 during the period of peak capacity when resources of the core network 104 are pushed to the limit as a result of a large quantity of network traffic being communicated between UEs 122 and other devices of the environment 100.

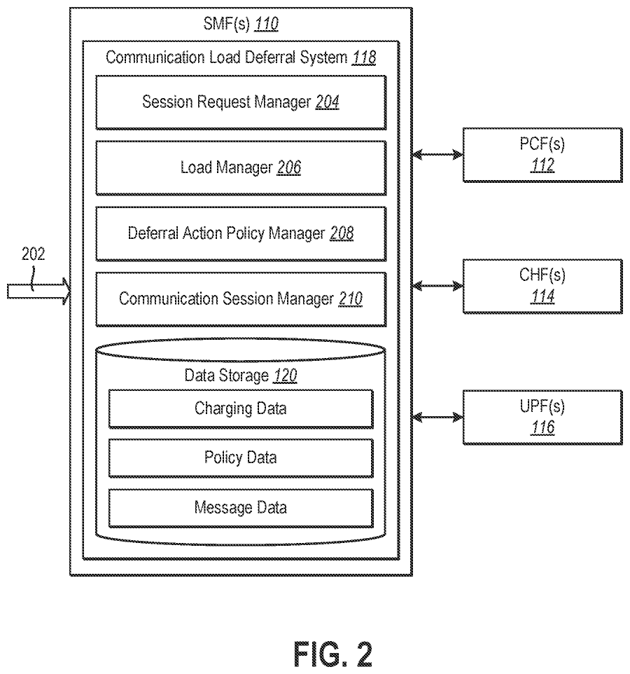

Additional detail will now be provided in connection with specific components of the load deferral system 118 and a plurality of example network functions in connection with FIG. 2. In particular, an example implementation of a load deferral system 118 will be discussed that is implemented on an SMF 110 similar to the SMF 110 discussed above in connection with FIG. 1 and which may be implemented within a similar environment as the environment shown in FIG. 1. While this and other examples are shown in which the load deferral system 118 is implemented on an SMF 110, it will be appreciated that the load deferral system 118 may be implemented on any network function or system of network functions that is tasked with handling or otherwise managing sessions (e.g., establishing, modifying, releasing sessions) between UEs and services of a telecommunications network.

In an example involving a 5G mobile network, the load deferral system 118 may be implemented on an SMF. Other environments may involve the load deferral system 118 (or select components of the load deferral system 118) being implemented on one or across multiple different network functions. In a 4G environment, for example, the load deferral system 118 may be implemented on a packet data network gateway (PGW) tasked with some of the similar functions as an SMF in a 5G network. In future 3GPP generations or in other telecommunications networks, other network functions tasked with managing communication sessions may have the load deferral system 118 implemented thereon.

As shown in FIG. 2, the load deferral system 118 may receive session requests 202 (or service requests). As used herein, a session request (e.g., session requests 202) may refer to any request received from a UE (e.g., via an AMF) which includes information about a source device, destination device, and/or any information about the service and/or operation being requested. In one or more embodiments, a session request involves a request to initiate or otherwise create a communication session between a UE and another endpoint or service on a cloud computing system. Other requests may involve messages that request an update, modification, deletion, or other operation to be performed with respect to a session (e.g., a communication session) between the UE and the telecommunications network.

As indicated above, the session requests 202 may be received from one or more UEs in communication with a telecommunications network. In one or more embodiments, the session requests 202 are relayed by or provided via an AMF on the core network positioned between the UEs (and the RAN) and the SMF 110.

As shown in FIG. 2, the load deferral system 118 includes a plurality of components that are tasked with performing features and functionalities of the load deferral system 118 described herein. In particular, as shown in FIG. 2, the load deferral system 118 includes a session request manager 204, a load manager 206, a deferral action policy manager 208, a communication session manager 210, and a data storage 120 on which collections of data 212 may be stored or otherwise be made accessible to the components 204-210 of the load deferral system 118. Each of these components 204-210 and associated features may be implemented across multiple server devices or on the same server device. In addition, while certain features may be performed by specific components of the load deferral system 118, it will be appreciated that these features are described by way of example, and may be performed by a single system implemented on the SMF or other similar type of network function (or combination of network functions).

As noted above, the load deferral system 118 includes a session request manager 204. The session request manager 204 may be tasked with performing tasks related to managing a session between a UE and the telecommunications network. In one or more embodiments, the session request manager 204 is tasked with generating, relaying and/or forwarding session request messages to other entities within the core network (e.g., such as the PCF(s) 112, CHF(s) 114, and/or UPF(s) 116).

As noted above, a session request may refer to a request or signal indicating a request for a variety of different operations to be performed with respect to one or more services on a telecommunications network. By way of example, a session request may refer to a create operation request in which a session is created between a UE and the telecommunications network, which may involve communications between the UE and any number of additional endpoints. As another example, a session request may refer to a delete operation quest in which a session is stopped, unregistered, or otherwise deleted from the telecommunications network and where resources previously allocated to that session can be allocated or repurposed for other sessions. As another example, a session request may refer to an update or modify operation in which an existing session is updated or modified in a requested manner.

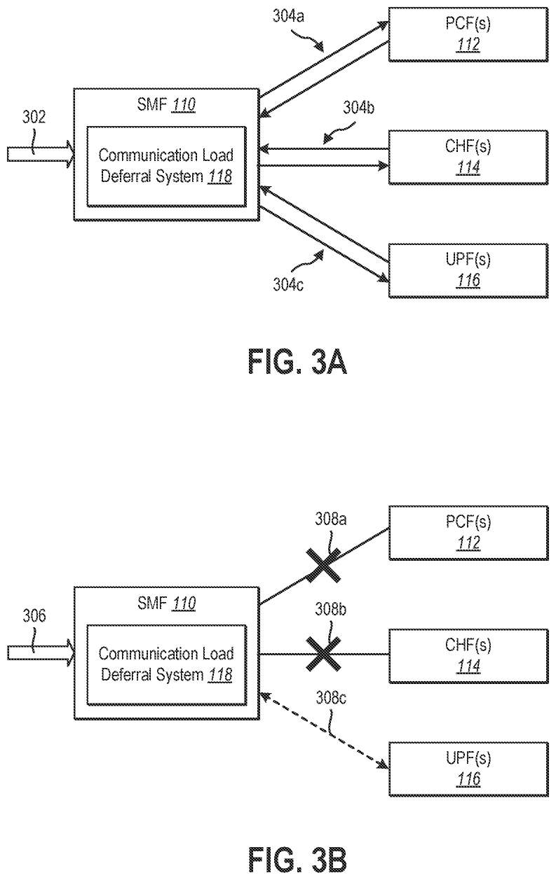

In any of the above-examples, the session request manager 204 receives the session requests 202 and determines how to process the requests. During non-peak periods of network traffic, the session request manager 204 may process these in a normal manner that generally complies to how the SMF 110 is conventionally configured to handle requests on the telecommunications network. In the event that the session requests 202 are received during a peak period of network traffic, the session request manager 204 may handle these requests in accordance with a deferral action policy, which will be discussed in further detail below. Indeed, specific examples in which certain types of requests are processed will be discussed below in connection with examples shown in FIGS. 3A-3B.

As further shown in FIG. 2, the load deferral system 118 includes a load manager 206. The load manager 206 may be tasked with determining or measuring a load metric of the SMF 110 and/or core network at a time that the session requests 202 are received. In one or more embodiments, the load manager 206 calculated or otherwise determines a load metric periodically. In one or more implementations, the load manager 206 determines load metrics as the session requests 202 are received at the SMF 110.

The load manager 206 may determine a current load in a variety of ways. In one or more embodiments, the load manager 206 determines the load based on a number of session requests 202 received over a period of time. In one or more embodiments, the load manager 206 determines the load by measuring available session capacity of the SMF 110 and/or other functions in communication with the SMF 110. In one or more embodiments, the load manager 206 receives load-related metrics (e.g., traffic quantity, session capacity) and determines a current load based on the received load metrics. In one or more embodiments, the load manager 206 determines a current load based on a CPU utilization associated with the SMF 110.

In one or more embodiments, the load manager 206 compares the determined load (e.g., a current load) against a threshold load to determine whether the SMF 110 and/or core network are operating in peak or non-peak conditions. For example, the load manager 206 may compare an observed CPU utilization of the SMF 110 against a threshold CPU utilization metric indicative of normal operating conditions or otherwise non-peak operating conditions and determine, based on the comparison, whether the core network is experiencing peak or non-peak operating conditions during a given period of time.

As shown in FIG. 2, the load deferral system 118 further includes a deferral action policy manager 208. The deferral action policy manager 208 may determine one or more operations to apply (or not to apply) based on whether a current load is associated with a peak or non-peak load being experienced by the core network. In the event that the load is less than a threshold indicative of a peak load condition, the deferral action policy manager 208 may instruct the SMF 110 to continue transmitting, forwarding, relaying, or otherwise processing the session requests 202 in a normal manner as the SMF 110 is configured to operate during non-peak conditions. Alternatively, in the event that the load equal to or greater than a threshold indicative of a peak load condition, the deferral action policy manager 208 may implement a deferral action policy in which one or more communications are modified, stopped, or deferred in an effort to increase an effective load or capacity of the SMF 110 and other network functions within the core network during the period of peak load on the core network.

As further shown in FIG. 2, the load deferral system 118 includes a communication session manager 210. The communication session manager 210 may be tasked with implementing instructions associated with communicating (or not communicating) with various network functions during the periods of peak and/or non-peak capacity. In one or more embodiments, the communication session manager 210 facilitates communication or stops certain communications during a peak load period based on instructions from a deferral action policy. Specific examples of actions that the communication session manager 210 can take in deferring certain actions will be discussed below in connection with FIGS. 3A-3B.

As will be discussed below, the deferral action policy manager 208 and communication session manager 210 may cooperatively determine and selectively implement communications with a PCF(s) 112, a CHF(s) 114, and a UPF(s) 116. For instance, based on a deferral action policy determined by the deferral action policy manager 208, the communication session manager 210 may defer communications between the SMF 110 and the PCF 114 for some period of time in lieu of obtaining a local policy that is locally stored on the SMF 110 while the core network is experiencing load conditions. In another example, and also based on the deferral action policy, the communication session manager 210 may defer communications between the SMF 110 and the CHF 112 for some period of time while the core network is experiencing peak load conditions. As another example, and also based on the deferral action policy, the communication session manager 210 may generate or modify one or more messages (e.g., precoded templates of standard messages) that are transmitted between the SMF 110 and UPF(s) 116 in a manner that decreases the CPU utilization during peak hours that is required in typical communications between the SMF 110 and the UPF 116.

As further shown in FIG. 2, the load deferral system 118 includes a data storage 120 including various types of data 212 stored or accessible thereon. In this example, the data storage 120 includes charging data, which the load deferral system 118 may maintain locally in lieu of transacting charges with the CHF responsive to the session requests 202. Indeed, the charging data may be any data accumulated that may be used at a later time (e.g., during non-peak load periods) for conducting charging transactions with the CHF(s) 112 that would normally be performed but for deferral action policies enacted by the load deferral system 118.

As further shown in FIG. 2, the data storage 120 includes policy data. The policy data may include any data or instructions associated with deferral one or more actions during a period of peak load capacity on the core network. In one or more examples described herein, the policy data includes rules associated with selective or deferred communications with the CHF 112, PCF 114, and/or UPF 116 as may serve a particular implementation.

As further shown in FIG. 2, the data storage 120 includes message data. The message data may include any information associated with messages that are received and/or transmitted by the SMF 110. For example, the message data may indicate source and destination data enabling the SMF 110 to ensure communications are transmitted and/or received by correct entities. The message data may also include, for example, information that is used for generating precoded templates of standard messages that may be used in communicating with the UPF 116 during periods of peak load capacity on the core network.

FIGS. 3A-3B illustrate example implementations in which the load deferral system 118 manages communications between an SMF 110 and additional network functions (e.g., a PCF 112, CHF 114, and a UPF 116). In particular, the load deferral system 118 manages communication of messages to and from the SMF 110 based on whether a core network (or the SMF 110) is experiencing a high volume of network traffic (e.g., a peak load condition) or a normal to low volume of network traffic (e.g., a non-peak load condition). As will be discussed below, the load deferral system 118 manages these communications in accordance with a deferral action policy based on rules that come into effect when a core network is operating at peak load conditions.

More specifically, FIG. 3A illustrates an example configuration of the load deferral system 118 in which the SMF 110 is not experiencing peak load conditions. In this example, the SMF 110 receives session requests 302 (e.g., from an AMF). The load deferral system 118 determines whether the SMF 110 is experiencing peak load conditions in accordance with one or more embodiments described herein, such as based on CPU utilization during a given period of time.

In this example, the SMF 110 processes messages and communicates with the respective network functions 112-116 in accordance with normal operating conditions. With respect to the PCF 112, the SMF 110 communicates with the PCF 112 via a first normal operating interface 304a to obtain policy rules for a given communication session and/or accounts associated with the communication session. Indeed, in response to each session request or other communications received at the SMF 110, the SMF 110 may interface with the PCF 112 to obtain associated policy information including session information, applicable quality of service (QOS) guarantees, and any other information to use in determining resources to allocate to the session as well as other tasks related to facilitating real-time management of subscribers, communication sessions, etc. As noted above, the SMF 110 may communicate with the PCF 112 as frequently as necessary and based on a number of service requests 302 received at the SMF 110.

In addition to interfacing with the PCF 112 to obtain policy rules for the communication session, the SMF 110 may communicate with the CHF 114 via a second normal operating interface 304b in response to each session request to generate a charging record inclusive of one or more communications or, in some instances, for each communication received at the SMF 110. In one or more embodiments, the SMF 110 causes a charging record to be generated or otherwise maintained for a communication by providing session information (e.g., a session identifier) and any other relevant information that the CHF 114 can use in generating a charging record and ultimately charging an account for the specific use of the telecommunications network by the UE from which the session requests 302 are originating.

As further shown in this example, the SMF 110 may communicate with a UPF 116 via a third normal operating interface 304c to manage one or more functions of the UPF. By way of example, the SMF 110 provides messages to the UPF 116 including instructions and/or parameters and manages operation of the UPF 116 with respect to programming data paths through the telecommunications network. Indeed, the SMF 110 may provide any number of communications to the UPF 116 in providing data path connectivity to a subscriber.

It will be appreciated that each of these normal operating interfaces 304a-c between the SMF 110 and the respective network functions 112-116 may operate as normally configured so long as the load deferral system 118 detects that the SMF 110 is not experiencing peak load conditions. For example, in one or more embodiments, the load deferral system 118 may cause the SMF 110 to interact with each of the network functions 112-116 for as long as the CPU utilization of the SMF 110 does not exceed a threshold utilization metric and/or so long as the load deferral system 118 determines that the SMF 110 is not utilizing greater than a threshold quantity of networking resources in communicating with each of the respective network functions 112-116.

As noted above, the load deferral system 118 may determine that the SMF 110 is experiencing load conditions and transition to a load deferring configuration as shown in FIG. 3B. In this example, the SMF 110 may receive a high quantity of session requests 306. As a result, the load deferral system 118 may determine that the SMF 110 is utilizing CPU resources above a threshold metric of CPU utilization and, based on the determination, transition to a peak operating mode in which the load deferral system 118 causes the SMF 110 to implement a deferral action policy.

In this example, the load deferral system 118 may implement a first deferral interface 308a between the SMF 110 and the PCF 112. Similar to the additional examples described herein (e.g., in connection with the CHF 114), the load deferral system 118 may effectively stop or otherwise defer communications between the SMF 110 and the PCF 114 for a period of time corresponding to the period of peak capacity.

In the illustrated example, rather than obtaining policy information from the PCF 112 based on session information provided to the PCF 112, the load deferral system 118 may determine one or more policy rules to apply to a given session in a number of ways. In one or more embodiments, the load deferral system 118 selects a predetermined local policy stored on the SMF 110 (or a data storage accessible to the SMF 110) in lieu of obtaining a policy based on the session request(s) from the PCF 112. In one or more embodiments, this local policy is a default policy that the SMF 110 utilizes for all sessions that are initiated or otherwise carried out during the period of peak capacity. The local policy may include any number of specific rules or instructions that minimize utilization of network resources. In one or more embodiments, the local policy may include rules and/or instructions in an effort to try and satisfy QoS requirements of as many communication sessions as possible.

In addition to implementing the first deferral interface 308a, the load deferral system 118 may cause a second deferral interface 308b to be implemented between the SMF 110 and CHF 114. In this example, the load deferral system 118 may defer any charging interactions between the SMF 110 and the CHF 114 for a period of time corresponding to the peak load condition (e.g., peak capacity) of the core network. Indeed, the SMF 110 and CHF 114 may cease any communication for the period of time corresponding to the peak load condition(s).

In this example, the load deferral system 118 may implement charging functions in a variety of ways. For example, in one or more embodiments, the load deferral system 118 causes charging data to be locally maintained on a storage accessible to the SMF 110 during the period of peak capacity. In one or more embodiments, the load deferral system 118 maintains a charging record for one or more sessions and holds the charging record until the period of peak capacity is done. Alternatively, in one or more embodiments, the load deferral system 118 may simply determine not to apply or even track charges to communications for a brief period of time, and allow communications to go uncharged for the brief period of time.

In addition to the first and second deferral interfaces 308a-b, the load deferral system 118 may cause a third deferral interface 308c to be implemented between the SMF 110 and the UPF 116. In contrast to the previous deferral interfaces, this third deferral interface 308c may enable communications to take place between the SMF 110 and the UPF 116. In contrast to the normal operation interface discussed above in FIG. 3A, however, the load deferral system 118 may facilitate a modification to communications that take place between the SMF 110 and UPF 116 to reduce expense of bandwidth and other network resources.

By way of example, in one or more embodiments, the load deferral system 118 invokes a deferral action policy that involves generating a pre-coded template of frequently transmitted messages (e.g., standard messages) that are transmitted to the UPF 116. In one or more embodiments, the load deferral system 118 causes the SMF 110 to transmit this message for each communication that passes through the SMF 110 and UPF 116. More specifically, the load deferral system 118 defers load by pre-coding packet forwarding control protocol (PFCP) messages during non-peak load periods. In one or more implementations (e.g., during an access network (AN) release or handover between NodeBs of the RAN), the only operation required will be encoding of the sequence and, in relevant cases, with the remote tunnel identifier and the rest of the PCFP message being pre-coded.

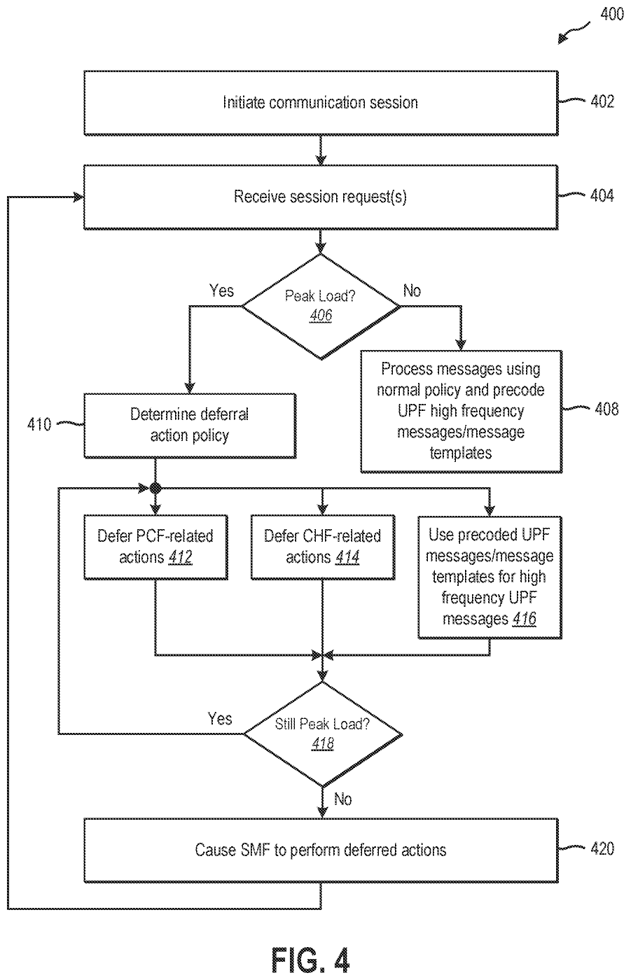

Additional detail will now be discussed in connection with an example series of acts 400 shown in FIG. 4 related to deferring one or more load-causing actions during a period of peak capacity on a core network. One or more embodiments of the acts described in FIG. 4 may be performed by an SMF or other network function on a core network. For ease in explanation, the acts shown in FIG. 4 will be described as performed by a load deferral system 118, though this may be interpreted as being performed by an SMF or server node on which the load deferral system 118 is implemented.

As shown in FIG. 4, the series of acts 400 includes an act 402 of initiating a communication session. This act of initiating the communication session may be performed prior to or after experiencing peak load conditions on the core network. In this specific example shown in FIG. 4, the communication session is initiated during a non-peak period.

The communication session may be a variety of real-time communication sessions involving real-time audio and/or video communication between one or more UEs or endpoints that are configured to communicate via a telecommunications network. In one or more embodiments, the communication session is an internet protocol (IP) multimedia subsystem (IMS) voice call.

As shown in FIG. 4, the load deferral system 118 performs an act 404 of receiving session request(s). As noted above, session requests may originate from a UE or other internal device of a cloud computing system and may be received at the SMF directly from another network function (e.g., an AMF). As noted above, the session requests may refer to any messages that are communicated to the SMF as part of a session between subscribers of the telecommunications network. In addition, the session requests may refer to a variety of request-types including, by way of example, create requests, modify requests, delete requests, or any other messages transmitted via the core network.

As shown in FIG. 4, the load deferral system 118 performs an act 406 of determining whether the SMF or core network is experiencing peak load conditions. As noted above, the load deferral system 118 may determine a current load based on an observed CPU utilization associated with the SMF, which may be caused by a significant number of received session requests over a period of time or other effect that results in a high CPU utilization by the SMF. In the event that the load deferral system 118 determines that the SMF is not experiencing peak load conditions (e.g., that the core network is not experiencing a period of peak capacity), the load deferral system 118 may perform an act 408 of processing messages under normal policies. In addition to processing the messages, the load deferral system 118 may use resources that are available during the non-peak load period to precode UPF high frequency messages (e.g., message templates) to be used during future periods of peak capacity.

Conversely, in the event that the load deferral system 118 determines that the SMF is experiencing peak load conditions, the load deferral system 118 may perform an act 410 of determining a deferral action policy to apply to communications and other messages received while the SMF is experiencing the peak load conditions. It will be appreciated that the deferral action policy may include any or all of the below rules for decreasing a load on the SMF and increasing the effective capacity of the core network in processing messages. For example, while FIG. 4 illustrates three possible actions that the load deferral system 118 may perform as a result of a given deferral action policy (or policies), one or more embodiments may involve only performing some portion of the deferral actions as may serve a particular embodiment or based on a particular type of session.

As a first example, based on a determined deferral action policy, the load deferral system 118 may perform an act 412 of deferring one or more PCF-related actions. For example, in one or more embodiments, the load deferral system 118 selects a predetermined and locally stored policy on the SMF rather than requesting a policy from the PCF based on specific session information, as would typically be done during periods of non-peak capacity when the SMF has sufficient bandwidth and resources to query the PCF for each communication session.

In this example, the load deferral system 118 may cause the SMF to handle communications for each of multiple communication sessions in accordance with some predetermined default policy that will be applied to some or all communication sessions while the SMF continues to experience peak load conditions. In one or more embodiments, specific rules of the default policy may be selected to conserve bandwidth resources. In one or more embodiments, specific rules of the default policy are selected in an effort to satisfy a majority of QoS parameters. In one or more implementations, the rules of the default policy are selected based on a combination of factors, such as a combination of bandwidth conservation and QoS considerations.

As a second example, based on a determined deferral action policy, the load deferral system 118 may perform an act 414 of deferring one or more CHF-related actions. For example, in one or more embodiments, the load deferral system 118 defers communications between the SMF and the CHF for a period of time while the SMF is still experiencing the peak load conditions. In one or more embodiments, the SMF maintains a local charging record for each of multiple communication sessions. In one or more embodiments, the SMF defers or simply stops maintaining charging records altogether for a brief period of time to reduce bandwidth utilization during the period of peak capacity.

As a third example shown in FIG. 4, the load deferral system 118 may perform an act 416 of using precoded UPF messages (e.g., message templates) for high frequency UPF messages. In this example, the load deferral system 118 may not necessarily reduce the number of communications between the SMF and the UPF, but rather modify the way in which the messages are generated and/or transmitted between the respective network functions. In one or more embodiments, the load deferral system 118 causes the SMF to generate a pre-coded template of a standard message and transmitting the pre-coded template of the standard message to the UPF. This can save significant processing bandwidth by sending out a pre-processed version of a message rather than processing and transmitting each message or communication as it is received at the SMF.

After performing one or more of the acts 412-216 in accordance with the deferral action policy, the load deferral system 118 may perform an act 418 of determining whether the SMF (or core network) is still experiencing peak load conditions. This may involve periodically checking processing utilization of the SMF to determine if the SMF is still overtaxed in processing incoming messages. In the event that the SMF continues to experience peak load conditions, the load deferral system 118 may continue performing some or all of the acts 412-416 in accordance with the deferral action policy.

Alternatively, where the load deferral system 118 determines that the SMF is no longer experiencing peak load conditions, the load deferral system 118 may perform an act 420 of causing the SMF to perform the deferred actions. This act of performing deferred actions may be accomplished in variety of ways.

For example, in the deferred CHF-related actions, the load deferral system 118 may cause the SMF to transmit any charging records that were locally generated or maintained on the SMF during the peak load period. In one or more embodiments, this involves transmitting charging records to charging servers to process the charging records as soon as possible after the peak load period is finished. In one or more implementations, the load deferral system 118 distributes the charging records to different servers in an effort to spread the load rather than overwhelming a specific network function or charging server with all of the charging records that were accumulated during the peak period.

In one or more embodiments, the load deferral system 118 spaces out distribution of the charging records by transmitting the charging records and other information to the CHF over a period of time and/or based on observed load conditions. For example, if the load conditions are slightly less, but still relatively close to the peak threshold, the load deferral system 118 may cause charging records to be more slowly transmitted than if the load conditions are significantly below the peak threshold and where the SMF and CHF have a substantial quantity of network and processing resources to spare.

In a similar example, the load deferral system 118 may transmit session information to obtain updated or correct policy data for various communication sessions from the PCF. In some instances, this may involve simply obtaining policy data for communications going forward, rather than attempting to obtain policy data for communications that were send during the period of peak load capacity.

In another example, the load deferral system 118 may also begin processing messages (e.g., PFCP messages) prior to transmitting the messages to the UPF. Indeed, the load deferral system 118 may stop using the pre-processed or pre-coded messages and instead process the messages as they are received in accordance with a normal operating policy of the SMF. In one or more embodiments, the load deferral system 118 may send the standard messages corresponding to the pre-coded messages that were sent during the period of peak load capacity. Similar to performing the deferred CHF-related actions, these messages may be sent in a paced manner (e.g., spaced out over time) so as to not overload SMF and/or UPF resources during periods of non-peak capacity. In one or more embodiments, the load deferral system 118 spaces out the messages based on current load conditions and may space them out more (e.g., send out at a slower rate) where the load conditions are close to peak capacity or space them out less (e.g., send out at a faster rate) where the load conditions are significantly less than the peak capacity.

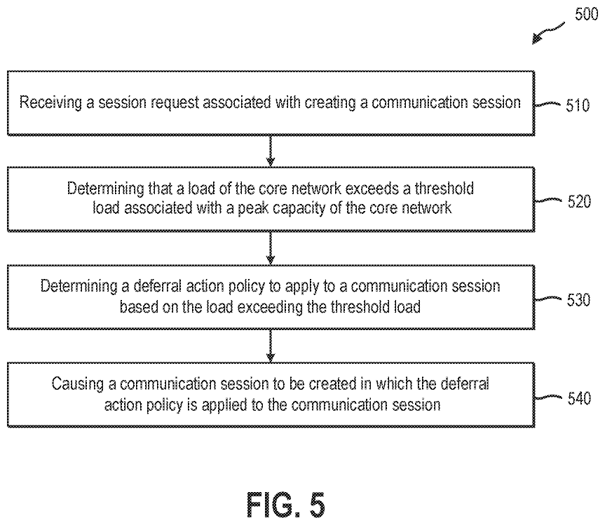

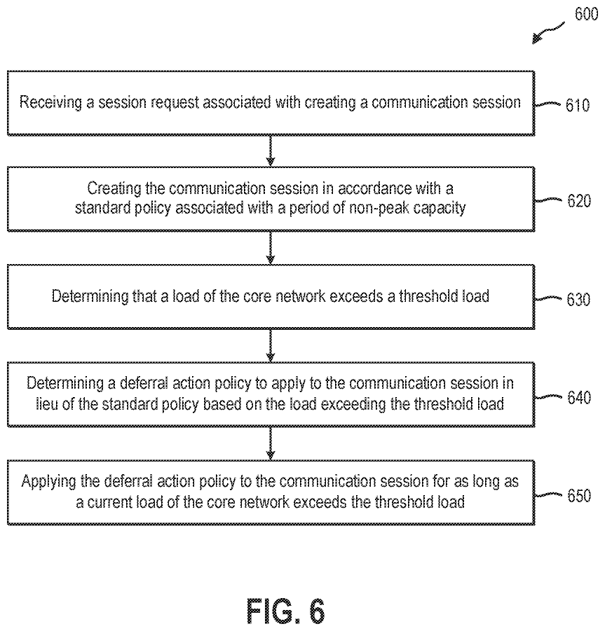

Turning now to FIGS. 5-6, these figures illustrates example flowcharts including series of acts deferring one or more actions by an SMF (or other network functions) during a period of peak load capacity on a core network in an attempt to effectively increase the quantity of bandwidth and processing resources and avoid potential signal degradation during the period of peak load capacity. While FIGS. 5-6 illustrates acts according to one or more embodiments, alternative embodiments may omit, add to, reorder, and/or modify any of the acts shown in FIGS. 5-6. The acts of FIGS. 5-6 can be performed as part of a method. Alternatively, a non-transitory computer-readable medium can include instructions that, when executed by one or more processors, cause a computing device to perform the acts of FIGS. 5-6. In still further embodiments, a system can perform the acts of FIGS. 5-6.

FIG. 5 illustrates an example series of acts 500 related to initiating a session during a peak load period on a core network in accordance with an action deferral policy in which certain load actions for a communication session are deferred for a period of time corresponding to peak load on the network function(s). As shown in FIG. 5, the series of acts 500 includes an act 510 of receiving a session request associated with creating a communication session. In one or more embodiments, the act 510 includes receiving, at the network function (e.g., an SMF), a session request associated with creating a communication session.

As further shown in FIG. 5, the series of acts 500 includes an act 520 of determining that a load of the core network exceeds a threshold load associated with a peak capacity of the core network. In one or more embodiments, the act 520 includes determining that a load of the core network at a time the session request is received exceeds a threshold load associated with a peak capacity of the core network in handing additional communication sessions.

As further shown in FIG. 5, the series of acts 500 includes an act 530 of determining a deferral action policy to apply to a communication session based on the load exceeding the threshold load. In one or more embodiments, the act 530 includes, based on the load exceeding the threshold load, determining a deferral action policy to apply to a communication session responsive to the session request.

As further shown in FIG. 5, the series of acts 500 includes an act 540 of causing a communication session to be created in which the deferral action policy is applied to the communication session. In one or more embodiments, the act 540 includes causing a communication session to be created responsive to the session request in which the deferral action policy is applied to the communication session. In one or more embodiments, the series of acts 500 includes an act of applying the deferral action policy to the communication session for as long as a current load of the core network exceeds the threshold load.

In one or more embodiments, the deferral action policy involves selecting a predetermined local policy stored on the network function in lieu of obtaining a policy based on the session request from a policy control function (PCF) on the core network. In one or more embodiments, the deferral action policy involves deferring charging interactions between the network function and a charging function (CHF) for a period of time corresponding to the peak capacity of the core network. In one or more embodiments, the deferral action policy involves generating a precoded template of a standard message and transmitting the precoded template of the standard message to a user plane function (UPF). In one or more embodiments, the series of acts 500 includes sending the standard message at a later time during a period in which the core network is experiencing non-peak capacity.

In one or more embodiments, the communication session is an IP Multimedia Subsystem (IMS) voice call. In one or more embodiments, the network function is a session management function (SMF) in the core network of a fifth generation (5G) mobile communication network.

In one or more embodiments, the series of acts 500 includes determining an updated load of the core network and determining that the updated load is within a threshold load associated with a non-peak capacity. The series of acts 500 may further include discontinuing, based on the updated load being within the threshold load, the deferral action policy and reverting to a standard policy associated with operation of the network function during non-peak capacity of the core network. In one or more embodiments, the series of acts 500 includes performing deferred actions not performed during the peak capacity of the core network as a result of the deferral action policy being applied to communications transmitted during a period of peak capacity, the deferred actions being performed in a paced manner.

Similar to FIG. 5, FIG. 6 illustrates a series of acts 600 related to deferring load for a communication session in a core network. As shown in FIG. 6, the series of acts 600 includes an act 610 of receiving a session request associated with creating a communication session. In one or more embodiments, the act 610 includes receiving, at a network function (e.g., an SMF), a session request associated with creating a communication session. In one or more embodiments, the communication session is an IP Multimedia Subsystem (IMS) voice call. In one or more embodiments, the network function is a session management function (SMF) in the core network of a fifth generation (5G) mobile communication network.

As further shown in FIG. 6, the series of acts 600 includes an act 620 of creating the communication session in accordance with a standard policy associated with a period of non-peak capacity. In one or more embodiments, the act 620 includes causing the communication session to be created using a standard policy associated with a period of non-peak capacity of the core network. The non-peak period may also be used to precode high frequency messages (e.g., message templates) to be used during the peak period.

As further shown in FIG. 6, the series of acts 600 includes an act 630 of determining that a load of the core network exceeds a threshold load. As further shown, the series of acts 600 includes an act 640 of determining a deferral action policy to apply to the communication standard in lieu of the standard policy based on the load exceeding the threshold load. In one or more embodiments, the act 640 includes, based on determining that the load exceeds the threshold load, determining a deferral action policy associated with a period of peak capacity of the core network to apply to the communication session in lieu of the standard policy.

As further shown in FIG. 6, the series of acts 600 includes an act 650 of applying the deferral action policy to the communication session for as long as a current load of the core network exceeds the threshold load. In one or more embodiments, the act 650 includes causing the communication session to continue in which the deferral action policy is applied to the communication session for as long as a current load of the core network exceeds the threshold load,

In one or more embodiments, the deferral action policy causes the network function to buffer communications to a charging function (CHF) and a policy control function (PCF) on the core network. In one or more embodiments, the series of acts 600 includes replaying the buffered communications to the CHF and the PCF after the period of peak capacity has concluded and during a later period of non-peak capacity of the core network. In one or more embodiments, the deferral action policy involves using a precoded template of high frequency UPF messages to encode and send messages to the user plane function (UPF).

FIG. 7 illustrates certain components that may be included within a computer system 700. One or more computer systems 700 may be used to implement the various devices, components, and systems described herein.

The computer system 700 includes a processor 701. The processor 701 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 701 may be referred to as a central processing unit (CPU). Although just a single processor 701 is shown in the computer system 700 of FIG. 7, in an alternative configuration, a combination of processors (e.g., an ARM and DSP) could be used.

The computer system 700 also includes memory 703 in electronic communication with the processor 701. The memory 703 may be any electronic component capable of storing electronic information. For example, the memory 703 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 705 and data 707 may be stored in the memory 703. The instructions 705 may be executable by the processor 701 to implement some or all of the functionality disclosed herein. Executing the instructions 705 may involve the use of the data 707 that is stored in the memory 703. Any of the various examples of modules and components described herein may be implemented, partially or wholly, as instructions 705 stored in memory 703 and executed by the processor 701. Any of the various examples of data described herein may be among the data 707 that is stored in memory 703 and used during execution of the instructions 705 by the processor 701.

A computer system 700 may also include one or more communication interfaces 709 for communicating with other electronic devices. The communication interface(s) 709 may be based on wired communication technology, wireless communication technology, or both. Some examples of communication interfaces 709 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 700 may also include one or more input devices 711 and one or more output devices 713. Some examples of input devices 711 include a keyboard, mouse, microphone, remote control device, button, joystick, trackball, touchpad, and lightpen. Some examples of output devices 713 include a speaker and a printer. One specific type of output device that is typically included in a computer system 700 is a display device 715. Display devices 715 used with embodiments disclosed herein may utilize any suitable image projection technology, such as liquid crystal display (LCD), light-emitting diode (LED), gas plasma, electroluminescence, or the like. A display controller 717 may also be provided, for converting data 707 stored in the memory 703 into text, graphics, and/or moving images (as appropriate) shown on the display device 715.

The various components of the computer system 700 may be coupled together by one or more buses, which may include a power bus, a control signal bus, a status signal bus, a data bus, etc. For the sake of clarity, the various buses are illustrated in FIG. 7 as a bus system 719.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. In a telecommunications network including a management network function for managing communication sessions, a method for deferring load in a core network of the telecommunications network, the method comprising:
receiving, at the management network function, a session request associated with creating a communication session;
determining that a load of the core network at a time the session request is received exceeds a threshold load associated with a peak capacity of the core network in handing additional communication sessions;
based on the load exceeding the threshold load, determining a deferral action policy to apply to a communication session responsive to the session request, the deferral action policy indicating one or more deferrable actions to be delayed or modified while the load of the core network exceeds the threshold load; and
causing a communication session to be created responsive to the session request in which the deferral action policy is applied to the communication session.

2. The method of claim 1, further comprising applying the deferral action policy to the communication session for as long as a current load of the core network exceeds the threshold load.

3. The method of claim 1, wherein the one or more deferrable actions includes selecting a predetermined local policy stored on the management network function in lieu of obtaining a policy based on the session request from a policy control function (PCF) on the core network.

4. The method of claim 1, wherein the one or more deferrable actions includes deferring charging interactions between the management network function and a charging function (CHF) for a period of time corresponding to the peak capacity of the core network.

5. The method of claim 1, wherein the one or more deferrable actions include using a precoded template of high frequency user plane function (UPF) messages to encode and send messages to the UPF during the period of peak capacity.

6. The method of claim 5, further comprising sending a standard message at a later time during a period in which the core network is experiencing non-peak capacity.

7. The method of claim 1, wherein the communication session is an IP Multimedia Subsystem (IMS) voice call.

8. The method of claim 1, wherein the management network function is a session management function (SMF) in the core network of a fifth generation (5G) mobile communication network.

9. The method of claim 1, further comprising:
determining an updated load of the core network;
determining that the updated load is within a threshold load associated with a non-peak capacity; and
discontinuing, based on the updated load being within the threshold load, the deferral action policy and reverting to a standard policy associated with operation of the management network function during non-peak capacity of the core network.

10. The method of claim 9, further comprising performing deferred actions not performed during the peak capacity of the core network as a result of the deferral action policy being applied to communications transmitted during a period of peak capacity, the deferred actions being performed in a paced manner.

11. In a telecommunications network, a method for deferring load in a core network of the telecommunications network, the method comprising:
receiving, at a management network function, a session request associated with creating a communication session;
causing the communication session to be created using a standard policy associated with a period of non-peak capacity of the core network;
determining that a load of the core network exceeds a threshold load;
based on determining that the load exceeds the threshold load, determining a deferral action policy associated with a period of peak capacity of the core network to apply to the communication session in lieu of the standard policy, the deferral action policy indicating or more deferrable actions to be delayed or modified while the load of the core network exceeds the threshold load; and
causing the communication session to continue in which the deferral action policy is applied to the communication session for as long as a current load of the core network exceeds the threshold load.

12. The method of claim 11, wherein the one or more deferrable actions include causing the management network function to buffer communications to a charging function (CHF) and a policy control function (PCF) on the core network.

13. The method of claim 12, further comprising replaying the buffered communications to the CHF and the PCF after the period of peak capacity has concluded and during a later period of non-peak capacity of the core network.

14. The method of claim 11, wherein the one or more deferrable actions include using a precoded template of high frequency user plane function (UPF) messages to encode and send messages to the UPF during the period of peak capacity.

15. The method of claim 11, wherein the communication session is an IP Multimedia Subsystem (IMS) voice call.

16. The method of claim 11, wherein the management network function is a session management function (SMF) in the core network of a fifth generation (5G) mobile communication network.

17. In a core network of a 5G mobile communication network, a system comprising:
at least one processor;
memory in electronic communication with the at least one processor; and
instructions stored in the memory, the instructions being executable by the at least one processor to:
receive, at a management network function, a session request associated with creating a communication session;
determine that a load of the core network at a time the session request is received exceeds a threshold load associated with a peak capacity of the core network in handing additional communication sessions;
based on the load exceeding the threshold load, determine a deferral action policy to apply to a communication session responsive to the session request, the deferral action policy indicating one or more deferrable actions to be delayed or modified while the load of the core network exceeds the threshold load; and
creating a communication session responsive to the session request in which the deferral action policy is applied to the communication session.

18. The system of claim 17,
wherein the one or more deferrable actions include selecting a predetermined local policy stored on the management network function in lieu of obtaining a policy based on the session request from a policy control function (PCF) on the core network, and
wherein the one or more deferrable actions include deferring charging interactions between the management network function and a charging function (CHF) for a period of time corresponding to the peak capacity of the core network.

19. The system of claim 17, wherein the one or more deferrable actions include using a precoded template of high frequency user plane function (UPF) messages to encode and send messages to the UPF during the period of peak capacity.

20. The system of claim 17, wherein the management network function is a session management function (SMF) in the core network of the 5G mobile communication network.
